(19) United States
(12) Patent Application Publication
(10) Pub. No.: US 2002/0106620 A1
(43) Pub. Date: Aug. 8, 2002

(54) Voting apparatus for disabled individuals

(76) Inventor: Micheal Barnum, Terrace Merriam, KS (US)

Correspondence Address: Albert L. Schmeiser, Schmeiser, Olsen & Watts, 18 East University Drive, Suite 101, Mesa, AZ, 85201, US

(21) Appl. No.: 09/778,401

(22) Filed: Feb. 7, 2001

(51) Int. Cl. G09B 19/00

(52) U.S. Cl. 434/306

(57) ABSTRACT

In accordance with the present invention, an information kiosk for use by disabled individuals, particularly in voting processes, is disclosed. The kiosk provides at least a first output device that outputs information to a user that is perceived using a first sense and a second output device that outputs information to a user that is perceived using a second sense, a first input device via which a voter inputs selections using a first physical action and a second input device via which a user inputs selections using a second physical action. A kiosk in accordance with the invention also provides a recording device to provide a record of a users selections and a storage device to retain information for output to a user.

### BACKGROUND OF THE INVENTION

1. Field of the Invention

The present invention relates to information kiosks accessible to disabled individuals, particularly a kiosk used as voting equipment in elections and balloting. More specifically, this invention concerns an apparatus for use by disabled individuals to cast their votes privately and with dignity.

2. Description of the Prior Art

The right to vote represents one of the fundamental rights of the individual within a free society. In countries such as the United States, the right to vote is firmly entrenched as the bedrock of democracy and freedom. The law protects and preserves an individual's right to vote regardless of that individual's race, gender, religion, ethnicity, or disability, and has largely removed impediments to voting previously erected based upon the aforementioned criteria of race, religion, gender, and ethnicity.

Unfortunately, simply removing legal impediments to voting provides little practical benefit to disabled individuals who are, due to physical considerations, unable to exercise their right to vote using the presently standard voting equipment. Legislation, most notably the Americans with Disabilities Act, mandates the removal of physical barriers to voting by disabled Americans, yet many jurisdictions lag in compliance with the full provisions of the Act. The reasons for this discrepancy between what the law mandates and what exists in fact are no doubt varied. The lack of broadly accessible, highly adaptable voting equipment no doubt contributes to the gap that exists between the full access to the ballot contemplated by law and limited access of reality.

The voting equipment used for an election should provide full and, to the maximum degree possible, independent access by all individuals regardless of their individual disabilities. Such full and independent access would allow disabled individuals to participate in the democratic process with full dignity. While a disabled individual is typically allowed to use the assistance of a friend, family member, or co-worker in casting his or her ballot, many individuals are reluctant to use such assistance, due either to the impracticalities of procuring assistance, embarrassment from having to request assistance, the inconvenience of relying upon another person's assistance to vote, or the simple desire to be independent. Thus, there exists a need for voting equipment that can accommodate a wide range of disabilities to enable all individuals to independently cast their votes.

While previous attempts have been made to allow individuals with particular disabilities to exercise their right to vote independently, the applicant is not aware of any prior attempt to create and provide truly universally acceptable voting equipment that allows an individual to privately vote regardless of that individual's personal handicap or disability.

For example, references have been made to the possibility of printing ballots in braille to allow blind or sight impaired individuals to independently examine ballot information. Unfortunately, simply providing ballot information in braille or large print does not address all, or even most, of the concerns of enhancing ballot access for disabled individuals. Numerous disabilities, other than merely sight impairment, can serve to block ballot access for a disabled individual. Providing ballot information in braille does nothing to enhance ballot access for individuals suffering from other disabilities. Moreover, not all sight impaired individuals are able to effectively read braille, particularly individuals whose sight impairment began later in life. Additionally, there could arise logistical or other concerns if the braille or large print ballots used in an election could be distinguished from the regular ballots cast in the election. In such a scenario, the secrecy of an individual's ballot would be placed at risk, which might discourage sight impaired individuals from voting at all. Even if the actual identity of voters using specialized ballots is never ascertained, the feeling of isolation and the fear of losing the secrecy of the ballot serves to discourage individuals from using such ballots.

Audio balloting has also been proposed as a means for enhancing access to the voting process for those suffering from disabilities or illiteracy. In such a system, the voter would listen to ballot information being read using a speaker or headphone system. A voter could indicate his or her votes either by providing physical input, such as marking a ballot as described by the audio, by pressing a button or using another physical input device in response to audio directions, or even by use of speech recognition processes. Unfortunately, audio balloting also has limitations that make it incapable of allowing all disabled voters access to the voting processes. Obviously, potential voters who suffer from hearing impairment or deafness are unable to benefit from such a system. Furthermore, the public nature of the voting process makes the use of speakers and voice recognition processes impractical for many scenarios. Furthermore, the use of a physical response to audio instructions and ballot information, of the type contemplated previously, are typically beyond the abilities of many disabled individuals, particularly those suffering from spinal cord injuries. For example, a quadriplegic individual might be unable to indicate a ballot selection in response to audio instructions by pressing a button with his or her finger. For these and other similar reasons, audio balloting is not a complete solution to the problem of ballot access for disabled individuals, although audio balloting can be used as part of the solution to this challenge.

Other proposals in the general art of voting processes, while not specifically targeted toward ballot access for disabled individuals, partially address some ballot access concerns. For example, the use of a touch screen mechanism that both displays ballot options and responds to a physical touch by recording ballot decisions can aid in ballot access for individuals who have some motor control, but who are unable to physically use standard voting equipment due to lack of motor control or a lack of physical strength.

Some prior work has been particularly directed towards enhancing voting access for individuals using wheelchairs. This work particularly focuses upon the creation of wheelchair accessible voting booths and the provision of voting equipment at a level and orientation suitable for use by an individual in a wheelchair. However, references to such devices contemplate that the wheelchair bound voter will have full or partial use of his or her upper extremities, and therefore does not address the needs of individuals who may have limited upper body motor control. Additionally, such systems typically do not address the needs of individuals who suffer from sight or hearing impairments.

Accordingly, a need exists for voting equipment that enables individuals with a broad range of disabilities, or even multiple disabilities, to exercise their right to vote privately and in a manner that protects the secrecy of their ballot, while at the same time maintaining appropriate security controls to prevent voter fraud or other voting irregularities. Ideally, such equipment should be durable, compact, and easily stored and transported.

### SUMMARY OF INVENTION

The present invention comprises a universally accessible kiosk particularly designed for use as a voting apparatus. The kiosk in accordance with the present invention combines physical accessibility for disabled individuals along with usability that incorporates multiple methods of outputting ballot information with multiple methods of inputting ballot selections to enable individuals with virtually any disability, or virtually any combination of disabilities, to independently and privately cast their ballot. Additionally, the voting apparatus in accordance with the present invention may include additional features to enhance the confidentiality of an individual's ballot, to enhance the security of the voting process by preventing voter fraud or other irregularities, and to facilitate the tabulation of election results. Furthermore, the voting apparatus in conjunction with the present invention is easily transported and stored between elections.

### BRIEF DESCRIPTION OF DRAWINGS

The invention may be better understood by reference to the drawings in which:

FIG. 1 illustrates a front view of a voting apparatus in accordance with the present invention in its most compact state for storage or transportation;

FIG. 2 illustrates the framework used in constructing a voting apparatus in accordance with the present invention;

FIG. 3 illustrates the telescoping curtain rod used in conjunction with the present invention;

FIG. 4 illustrates the cable system used to open the voting apparatus in accordance with the present invention for use;

FIG. 5 illustrates a partially assembled voting apparatus in accordance with the present invention;

FIG. 6 illustrates a fully assembled voting apparatus in accordance with the present invention;

FIG. 7 illustrates a rear view of the voting apparatus in accordance with the present invention in its most compact state for storage and transportation;

FIG. 8 illustrates a screen assembly for use in conjunction with the present invention;

FIG. 9 further illustrates a screen assembly in accordance with the present invention;

FIG. 10 illustrates schematically the operable elements of the present invention;

FIG. 11 illustrates a method of securely sealing a voting apparatus in accordance with the present invention for storage or transport; and

FIG. 12 further illustrates a method for securely sealing a voting apparatus in accordance with the present invention for storage or transportation.

### DETAILED DESCRIPTION OF THE PREFERRED EMBODIMENT

The present invention comprises a voting apparatus that allows for the dignified access and use of the apparatus for voting purposes by individuals with a broad range of disabilities or a combination of disabilities. The present invention addresses three broad areas to enable access by a wide range of individuals. While one skilled in the art will certainly realize these areas frequently overlap, and often are addressed in a unitary fashion, it is nevertheless useful to view the present invention in terms of these three factors. The three factors critical to the implementation of the present invention are the physical accessibility of the voting apparatus, the means of providing ballot information to a voter, and the means of allowing a voter to input his or her ballot selections. Additionally, a voting apparatus in accordance with the present invention may also address issues of ballot privacy and confidentiality. A voting apparatus in accordance with the present invention also may include features to assist in tabulating and reporting election results and enhance the security of the balloting system.

The physical accessibility aspect of the present invention involves the physical configuration of a voting apparatus to allow disabled individuals to fully access and use the equipment provided therein. For example, the voting apparatus used in accordance with the present invention should be configured to allow access and use by an individual using a wheelchair, even if that wheelchair is oversized. Care should be taken to provide access for use by individuals using both conventional wheelchairs and motorized wheelchairs such as are used by some individuals, particularly those suffering from limited use of their upper extremities.

The physical accessibility attribute of the present invention also relates to the configuration and placement of devices within the voting booth. For example, any equipment used for voting purposes should at least be positioned so as to facilitate access by an individual in a wheelchair, and also should be adjustable in its height, lateral position, and orientation to allow for a full range of access by different individuals. One way to provide for adjustability of peripheral devices is the use of adjustable position support arm devices. Such devices are well known in the art and are available from a variety of companies and manufacturers. One such manufacturer sells these devices under the name of “Magic Arm”. Such devices allow an object or apparatus held by the arm to be flexibly positioned in a wide range of area and then securely locked in place.

The voting apparatus in conjunction with the present invention also provides for a variety of methods to output ballot information to a voter. Ballot information may include the names and party affiliations of candidates, the office sought by a set of candidates, the text of voter propositions, or any other information placed on a ballot by law or custom. In general, the output devices used with the voting apparatus in accordance with the present intention output ballot information to a voter in forms that allow voters to perceive that ballot information using different senses. This variety of output devices accommodates individuals with a variety of disabilities, or a combination of disabilities, that may prevent an individual from perceiving ballot information presented in some ways. For example, the voting apparatus in accordance with the present invention provides first output device to provide ballot information to a voter such that the voter perceives information provided by the first device using a first sense. The voting apparatus in accordance with the present invention further includes a second output device to provide ballot information to a voter such that the voter perceives information provided by the second device using a second sense different than the first sense. A third output device could also be provided to provide ballot information to a voter such that the voter perceives the information provide by the third output device using a third sense different from the first sense and the second sense. By way of a more specific example, the first output device could be a screen or monitor that presents information visually, the second output device could be headphones that presents information audibly, and the third output device could be a refreshable brailled board that present information tactilely. The senses of taste and smell could theoretically be used, either in place of one or more of the above senses or in conjunction with a fourth output device and/or a fifth output device, but such a use of the senses of taste and smell appears impractical at this time.

Ballot information may be provided visually in a variety of means. The preferred method of visually providing ballot information is through the use of a touch screen. Other examples of appropriate visual presentations of ballot information include presenting the ballot information on a television monitor or computer screen, or to use other types of monitors. Ballot information may be presented in an audio format using either speakers or headphones for use by the voter. Typically, the use of headphones would be preferable, as this would allow an individual to vote without disturbing others at the polling place and preserves the privacy of the individual voting. The use of audio information is not limited to any particular media, and accordingly may be provided in any format, whether digital or analogue, whether presently existing or developed in the future. It should be noted that in some circumstances it may be desirable to provide audio ballot information in a variety of languages to facilitate voting by individuals who may not speak or adequately understand the majority tongue. Ballot information can further be provided in a tactile manner. One means of providing information in a tactile manner would be to prepare copies of ballots in a braille format. Preferably, tactile ballot information can be provided through use of a device commonly referred to as a “refreshable braille board”. A refreshable braille board comprises a pliable membrane stretched over a plurality of moveable pins. The moveable pins are operated to raise portions of the membrane to form braille characters. Thus, a refreshable braille board may be used to output ballot information in a braille format that may be altered to present appropriate ballot information as a voter makes his or her selections.

The voting apparatus in accordance with the present invention should also include multiple methods for receiving and recording a voter's ballot selections. Ballot selections may include a voter's candidate selections, yes or no votes on a ballot proposition, or the outcome of any other decision placed on a ballot for voter consideration. As was the case with the devices for outputting ballot information to the voter, the input devices used to input a voter's ballot selections should provide for the use of a variety of input methods to allow individuals with a wide range of disabilities or combinations of disabilities to effectively input their ballot decisions.

All input devices presently known require some physical action, although the physical action may be no more than a blink or blowing a puff of air, to input a selection or other information. The voting apparatus in accordance with the present invention should utilize input devices that allow a voter to input ballot selections using a variety of physical actions so that a voter who is, for whatever reason, unable to utilize one input device may utilize another input device. The voting apparatus should, at a minimum, include a first input device allowing a voter to input ballot selections via the first input device using a first physical action and a second input device allowing a voter to input ballot selections via the second input device using a second physical action. The first input device may be, for example, a touch screen via which a voter inputs ballot selections using the physical act of touching the screen. The second input device may be, for example, a microphone via which a voter inputs ballot selections using the physical act of speaking. Of course, other input devices, some of which are described herein, may also serve as a first input device and/or second input device. Additional input devices may also be used as a third input device, a fourth input device, and the like.

One input device that would allow voters with limited but existing motor ability is a touch screen monitor, which may be used to both display ballot information and to receive a voter's ballot decisions. In such a system, a voter could input his or her ballot selections by touching the appropriate section of the screen. For example, a voter could indicate a vote for a particular candidate by touching that candidate's name on the screen or by touching a designated area of the screen adjacent to the candidate's name. Conventional computer graphical user interface input devices, such as a mouse or a joystick, can also be used, and may be desirable as an alternative entry method even if a touch screen is used. One skilled in the art will realize that such input devices should preferably be of a type that allows individuals with limited tactile control to use them.

Other ballot selection input devices and methods are also possible for use and conjunction with the present invention. Other possible input devices for use with the present invention are buttons, switches, or other devices, that are activated to indicate a ballot selection. Such devices could work particularly well in conjunction with audio output of ballot information. In such a scenario, the voter would activate the input device to indicate which of the ballot selections he or she wishes to choose.

Input devices other than those typically requiring physical activation using a persons hands should be provided to enable voters who lack substantial ability to control their upper extremities can still cast their votes privately and effectively. One such device is typically referred to as a “sip and puff”. A sip and puff allows an individual, typically a quadriplegic individual, to register information by either sipping or puffing on a straw like device. Preferably, a sip and puff device should be incorporated into a voting booth and apparatus in accordance with the present invention, so as to allow the widest possible range of individuals to use the voting apparatus.

The voting apparatus in accordance with the present invention can also allow for the use of individual voter's automated assistance equipment to be used in the voting process. Presently, some disabled individuals use technologically advanced wheelchairs with a varied degree of automation to assist them in their lives. In addition to providing a means of locomotion, some of these wheelchairs include, either originally or through later addition, devices such as the sip and puff described above, or specialized joysticks to allow even individuals with very limited motor control to use them, or other devices specially adapted to a particular individual's needs. Many such wheelchairs or devices possess the ability to be connected to other devices to allow the individual using them to effectively interface with the other equipment. These devices employ a control module that receives signals from an individual device, such as a sip and puff, and then converts those signals to a form that may be transmitted to other computerized devices operating the appropriate communication software. The control module may communicate with appropriately compatible equipment either by a physical connection using an appropriate cable, or by other means such as an infrared signal. While different manufacturers of equipment may use differing standards for their devices, it is desirable to construct a voting apparatus in accordance with the present invention that is capable of communicating, using whatever means is deemed appropriate, with as many differing types of auxiliary peripheral equipment and automated wheelchairs as is possible. In general, these devices used by individuals which may interface with the voting apparatus but which are not provided with the voting apparatus itself are referred to as “auxiliary peripherals” herein.

The present invention may also serve to facilitate the tabulation and reporting of election results. For example, a computer provided with the present invention may record and tabulate the votes cast using the apparatus. The invention may further be equipped with network capabilities by use of a modem or network card that allows it to electronically transmit voting records to another computer at the polling place or to a remote centralized location for tabulation and reporting.

An apparatus in accordance with the present invention also serves to enhance ballot security and election integrity. For example, by redundantly recording a voter's ballot selections, as described below, the risk of losing votes is greatly reduced. By recording votes using methods not typically readable by direct human perception, as also described below, ballot secrecy is enhanced and selective vote tampering discouraged. Additionally, the apparatus in accordance with the present invention provides means to verify a voter's registration information on the apparatus itself, thereby automating and facilitating the process of confirming a voter's eligibility.

A voting apparatus in accordance with the present invention may also be collapsible to allow for its easy storage and transportation. A voting apparatus in accordance with the present invention may be designed to expand into a full size and easily acceptable voting booth while in use, yet collapse into a relatively small size within an easily stored shape, such as a substantially rectangular box, for use during storage and transportation. If a voting apparatus in accordance with the present invention is to be transported or stored in potentially damaging climate conditions, the outer surface of the apparatus should be substantially sealed to prevent water or other elements from entering into the voting apparatus and causing damage.

One skilled in the art will realize that the broad parameters described above as well as the specific embodiment of the present invention described below can be employed for uses other than voting. In a broad sense, the present invention can be conceived as a universally accessible kiosk for use in a multitude of purposes. Examples of such kiosks are often located in airport terminals and other public places and can provide individuals access to e-mail or other internet services, financial services such as bank accounts, insurance services, or any other of a number of other automated services. While the present invention is described in considerable detail below for specific use in the voting process, it is to be appreciated that the present invention will find widespread application in areas other than voting.

It should be appreciated that a voting apparatus in accordance with the present invention is expected to comply fully with the accessibility requirements of the Americans with Disabilities Act. It should be further noted, however, that a voting apparatus in accordance with the present invention may be readily and easily employed to greatly exceed the accessibility requirements of the Act. While the Act provides certain appropriate minimum standards of accessibility, the present inventor is of the opinion that those standards represent only a basic level of accessibility that should be exceeded when possible and reasonably feasible.

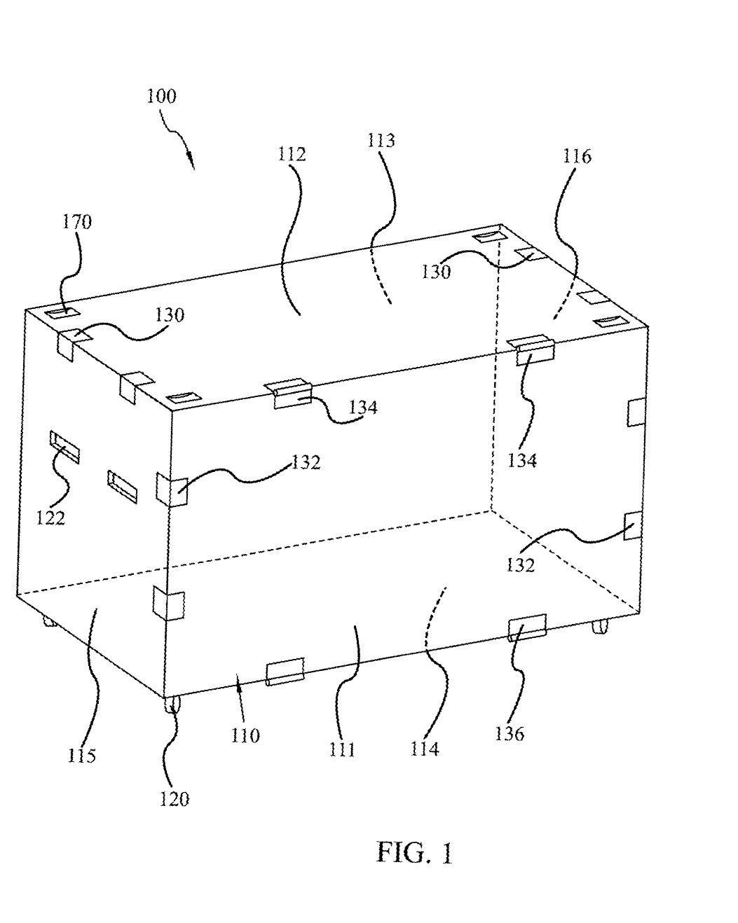

Within the broad parameters set forth above, an embodiment of the present invention is disclosed in conjunction with the accompanying drawings. FIG. 1 illustrates a voting apparatus 100 in accordance with the present invention in its collapsed and most portable mode. The voting apparatus 100 collapses into a substantially rectangular box 110. The sides of the box 110 can preferably be constructed of laminated lumber, although other materials such as plastics or metals could be used for this purpose. The box 110 can be described as possessing a front face 111, a top face 112, a rear face 113, a bottom face 114, a left face 115, and a right face 116. It should be noted that the box 110 defines an interior and an exterior thereof. The entire box 110 rests upon four wheels 120 to allow for the easy movement of the voting apparatus 100. The wheels 120 used on the voting apparatus may be standard flip lever locking wheels that allow the wheels 120 to be secured to prevent rolling while the voting apparatus 100 is in use, and which can then be unlocked to allow for the easy movement of the voting apparatus 100 before and after polling is conducted. The left face 115 and the right face 116 of the box 110 also may have a pair of handles 122 attached thereto to allow polling workers to more easily move the voting apparatus 100 into position. It will be further noted that, as shall be explained in further detail below, the box 110 is partially disassembled to allow the voting apparatus 100 to be used to cast ballots. Accordingly, there are appropriate latches 130 to removably secure the top face 112 to the left face 115 and the right face 116, such that the left face 115 and right face 116 abut the top face 112 without being permanently secured thereto. Additional latches 132 removably secure the front face 111 to the left face 115 and to the right face 116, such that the front face 111 abuts the left face 115 and the right face 116 without being permanently affixed thereto. Hinges 134 join the top face 112 and the front face 111. Additional hinges 136 join the front face 111 to the bottom face 114. The hinges 134, 136 serve to allow for the partial disassembly of the box 110 in a manner that shall be described more fully below.

Also referring to FIG. 1, four grooves 170 are provided within the top face 112 of the box 110. These grooves 170 serve to receive the wheels 120 of another voting apparatus 100 assembly so that the apparatuses may be stacked for easy storage. The grooves 170 may be rounded so as to receive and retain in place the wheels of other voting apparatus.

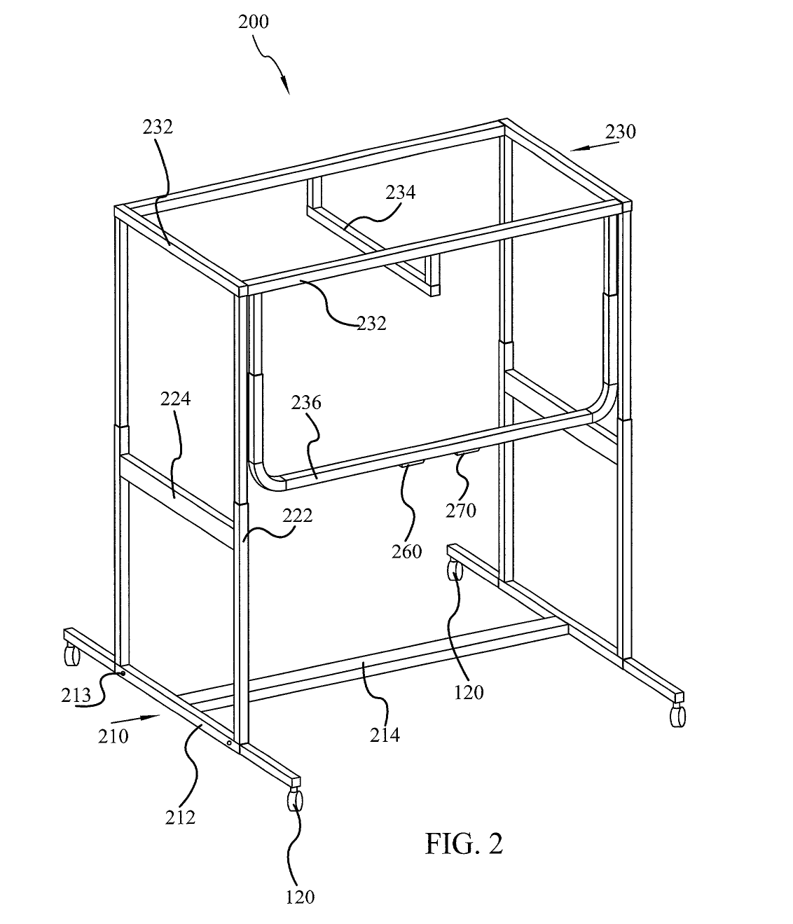

Referring now to FIG. 2, the frame 200 used in the construction of a voting apparatus 100 in accordance with the present invention is illustrated. Preferably, the frame 200 of the voting apparatus 100 is constructed of a high grade lightweight aluminum composite material formed into hollow tubing.

The base 210 of the voting apparatus 100 is formed using a pair of telescoping horizontal rods 212 that extend to provide a stable base for the voting apparatus 100 when in use. Locking spring pins 213 may be used to secure the telescoping horizontal rods 212 in their fully extended and fully retracted positions. One skilled in the art will realize that the use of locking spring pins requires that appropriately sized holes be made at appropriate locations along the inner part of the telescoping horizontal rods to allow them to be locked in place. A horizontal rod 214 extends orthogonally between the two telescoping rods 212 to join the two telescoping rods 212 rigidly together to provide for the structural stability of the voting apparatus 100.

Four vertical telescoping rods 222 extend from the base 210. The telescoping rods 222, are illustrated in FIG. 2 in their fully extended position. One purpose of these vertical telescoping rods 222 is to provide a framework upon which to construct and maintain the voting apparatus 100. These four vertical rods 222 also telescope upwards to allow access to the interior of the box 110 when the voting apparatus 100 is in operation, as shall be explained in greater detail shortly. Horizontal cross bars 224 extend between the vertical telescoping rods 222 at the ends of the frame 200 corresponding to the left face 115 and the right face 116 of the box 110. The horizontal cross bars 224 may be located near the upper end 223 of the vertical telescoping rods 222 when the vertical telescoping rods 222 are in their shortest, non-extended position. The horizontal cross bars 224 provide enhanced rigidity and structural integrity to the voting apparatus 100, but also further provide for the mounting of adjustable position support arm devices thereon for purposes that shall be more fully described below, these support arms serving to hold various articles of peripheral equipment for use by voters using the voting apparatus 100.

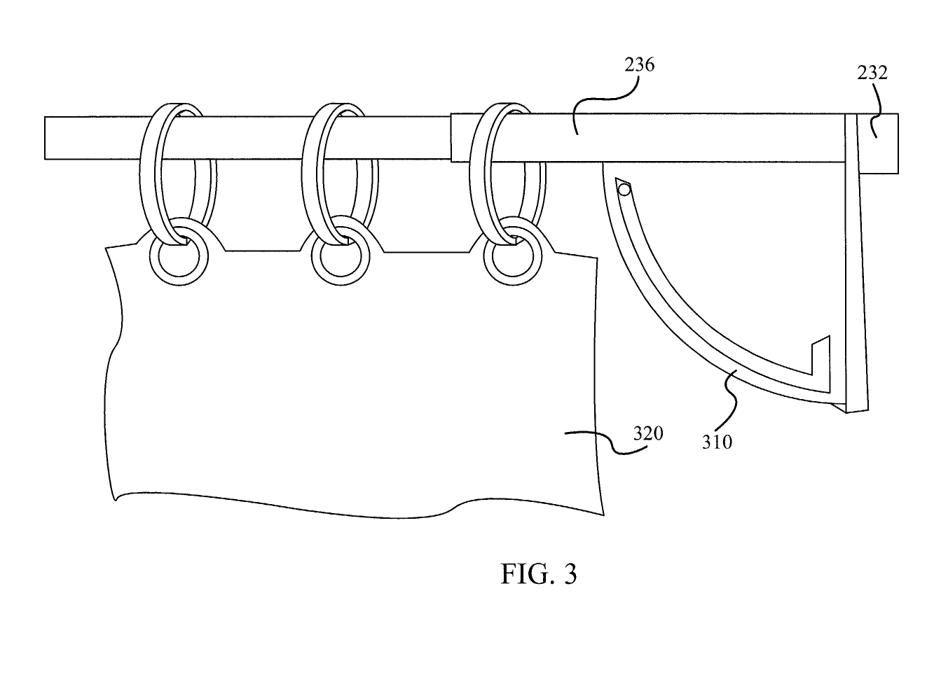

The canopy portion 230 of the frame 200 comprises four bars 232 arranged in a rectangular fashion to provide structural support to the top face 112, as well as for other purposes that shall subsequently be described. A support beam 234 extends across the canopy portion 230 substantially parallel to the left face 115 and the right face 116 to support voting equipment such as the touch screen used with the voting apparatus 100 in a manner described below. The support beam 234 is configured to allow an adjustable position support arm device to be slidably mounted thereon to further provide mobility and adaptability in positioning the touch screen. A telescoping curtain rod 236 is affixed to the front of the canopy portion 230 of the frame 200. This telescoping curtain 236 rod may be folded outwards and upwards and using hinges 310 then extended outward from the canopy portion 230 as illustrated in FIG. 3. A curtain 320 may then be suspended from the curtain rod 236 to provide privacy for the individual voter using the voting apparatus 100. While the curtain may comprise any screening device that substantially obscures a voter using the apparatus 100 from the view of others present at the polling location a power curtain or other automated curtain device allows a wider range of individuals to close and open the curtain. The use of a slidable curtain, rather than a door, facilitates wheel chair access to the voting apparatus 100, even when an oversized wheelchair is used.

It should be noted that the frame 200 serves to support the box 110. The canopy portion 230 directly supports that top face 112 and indirectly supports the front face 111, which is hingedly affixed to the top face 112 using hinges 134, and a portion of the bottom face 114, which is hingedly attached to the front face 111 using hinges 136. The remaining portion of the bottom face 114 is affixed to the base 210. The back face 113, the left face 115, and the right face 116 may be affixed to the base 210 and/or the vertical rods 222 such that the back face 113, left face 115, and right face 116 remain in place when the canopy portion 230 is raised.

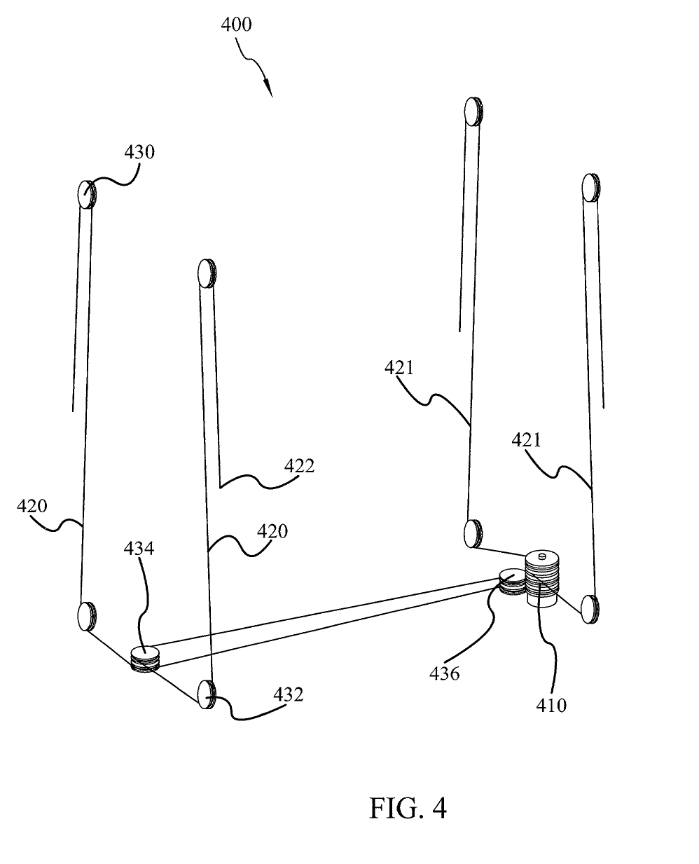

Referring now to FIG. 4, the cable and pulley system 400 used in raising and lowering the canopy portion 230 is illustrated. An electric motor and winch 410 may provide the power necessary to raise and lower the canopy portion 230, the top face 112, the front face 111, and portion of the bottom face 114. Alternatively, a hand crank or other powered winch may be used to replace the electric motor and winch 410. Two long cables 420 and two short cables 421 are attached to the vertical telescoping rods 222 at their terminal ends 422. The terminal ends 422 are attached to the interior of the vertical telescoping rods 222. The long cables 420 extend from their terminal ends 422, over vertical pulleys 430 located at the upper ends of the vertical telescoping rods 222, over vertical pulleys 432 located at the bottom ends of the vertical telescoping rods 222, along the horizontal bars 212 to horizontal pulleys 434, and then to the motor and winch 410. The short cables 421 extend from their terminal ends 422, over vertical pulleys 430 located at the upper ends of the vertical telescoping rods 222, over vertical pulleys 432 located at the bottom ends of vertical telescoping rods 222, and then to the motor and winch 410. Due to safety concerns, it is preferable to shield the cables 420, 421 as much as possible. One effective manner of shielding the cables 420 is to place the pulleys 430, 432, 434 within the hollow tubing from which the frame 200 is constructed, so that the cables 220, 221 extend within the tubing itself. Of course, access to the pulleys 430, 432, 434 should be provided to allow for servicing and any necessary repairs.

The canopy portion 230 may be raised or lowered by activating the electric motor and winch 410 to either extend or retract the cables 420, 421. Appropriate power may be supplied to the electric motor and winch 410 by means of an A/C connection or a battery. The switch to activate or deactivate the electric motor and winch 410 may be located on the exterior of the box 110 to allow easy access thereto.

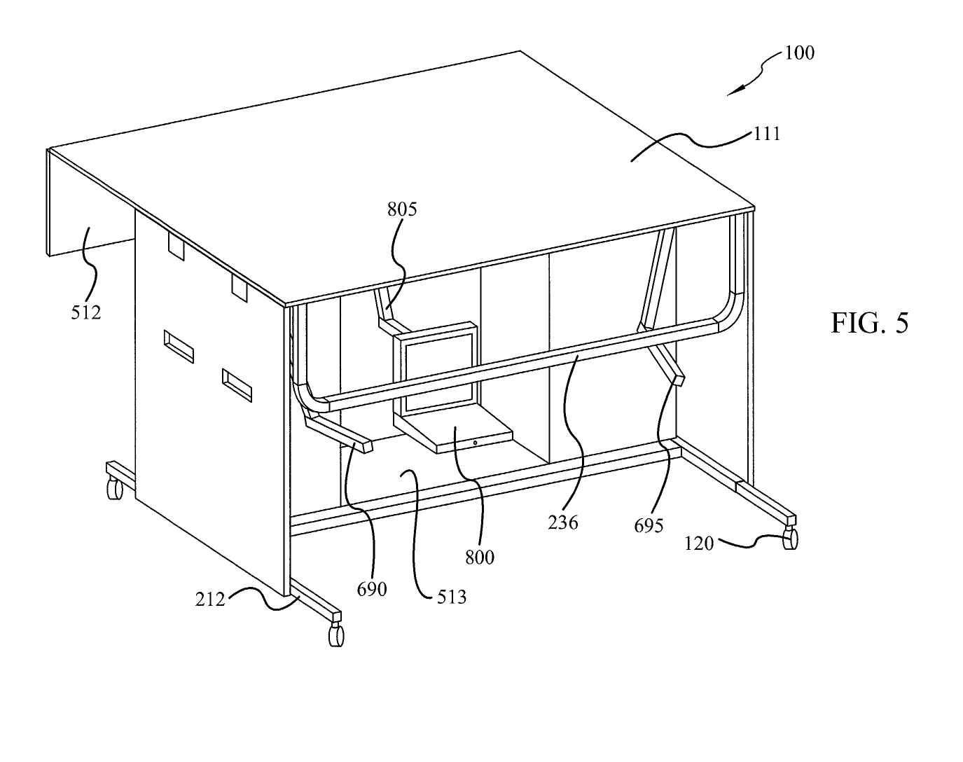

Referring now to FIG. 5, a partially opened and assembled voting apparatus 100 is illustrated. As can be seen in FIG. 5, the front face 111 of the voting apparatus 100 and a portion of the bottom face 114 have been folded over the top face 112 of the box 110 using hinges 132, 134. As illustrated in FIG. 2, the bottom face 114 actually comprises two separate pieces, a first portion 512 of which is attached by the hinges 134 to the front face 111 and a second portion 513 which is affixed to the base 210. Also shown in FIG. 5, the horizontal telescoping rods 212 are extended such that the wheels 120 provide a wide and stable base for the voting apparatus 100 during the voting process.

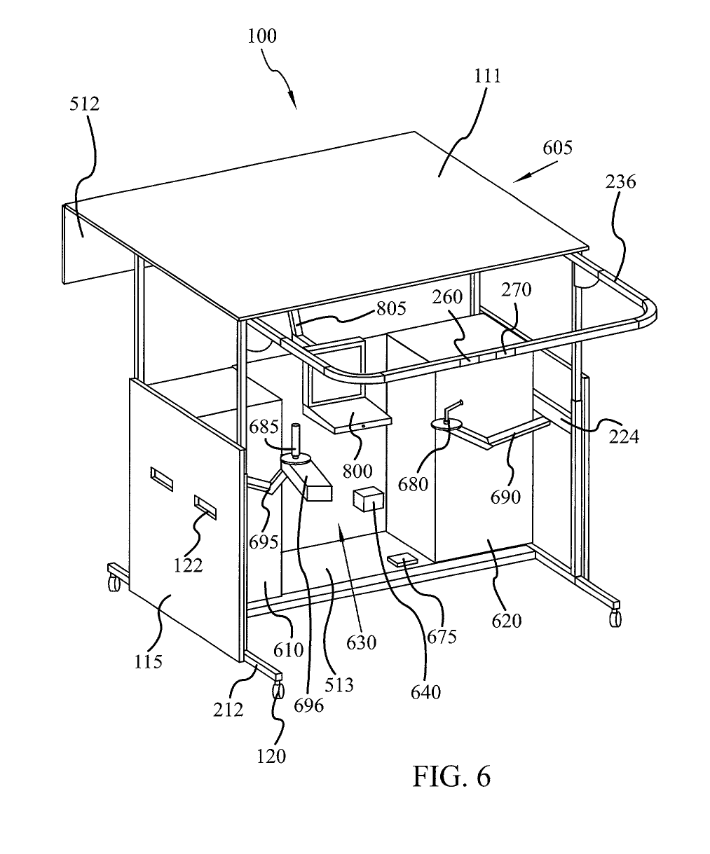

Referring now to FIG. 6, the voting apparatus 100 in accordance with the present invention is illustrated in a further step of set up. As can be seen in FIG. 6, the canopy 605 comprises the front face 111, portion 512 of the bottom face 114, and the top face 112 supported by the canopy portion 230. The canopy 605 has been elevated above the rest of the box 110 by use of the cable and pulley system 400 described above. The canopy 605, may be raised to a height of approximately six feet above the polling place floor to allow most individuals, particularly individuals using wheelchairs, to access the apparatus 100 beneath the canopy 605. It is to be further noted in reference to FIG. 6 that the interior of the box 110 includes a first compartment 610, a second compartment 620, and a space 630 between these two compartments.

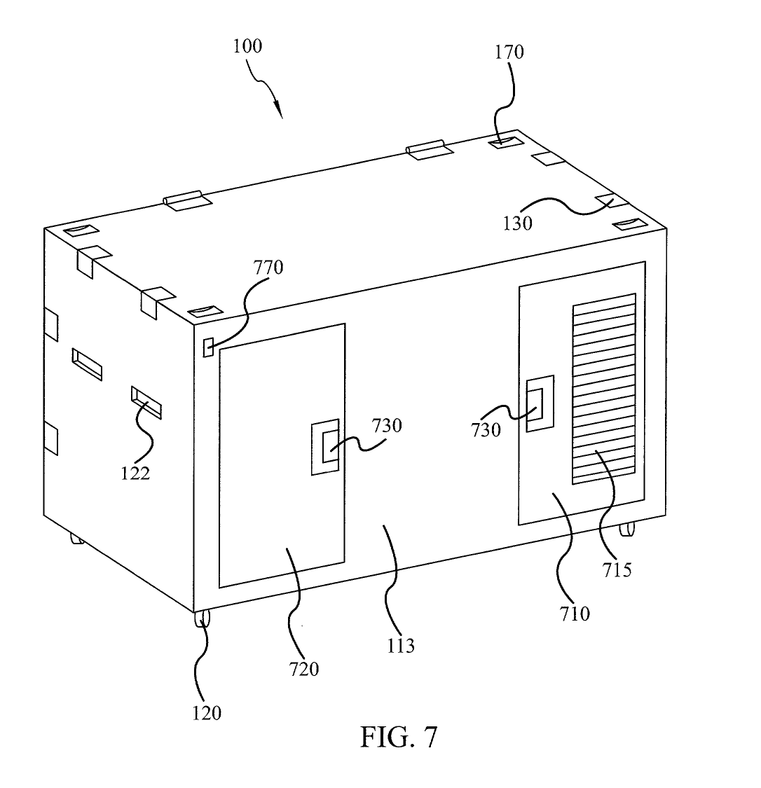

Referring now to FIG. 7, a rearview of the voting apparatus 100 is shown. As can be seen in FIG. 7, a first door 710 and a second door 720 are provided on the back face 113 of the box 110. These doors 710, 720 provide access to the first compartment 610 and second compartment 620 by the appropriate voting officials.

The first compartment 610, which is accessed through the first door 710, contains a computer system for use in recording and tabulating votes. To accommodate these electronic devices' heat dissipation needs, the first door 710 includes a vent 715 to allow proper cooling of the equipment contained within the first compartment 610. The computer system contained within the first compartment 610 is a redundant server with five hard drives. Such a server will, among other functions described elsewhere herein, save a voter's ballot selections on each of the five hard drives, to provide backup capabilities should one or more of the included hard drives fail or encounter an error. The first compartment 610 also contains a printer back up to provide a printed copy of voting records. While any form of printer may be used, a black and white laser printer, such as is typically used for printing cash register receipts, has the advantage of being very reliable, stable, and easy to use. While some users may appropriately use inkjet or thermal paper printers, the use of such printers is generally undesirable due to durability and other concerns. The printer may be used to print ballot selections in any form, but for purposes of the present embodiment, a bar code or other computer readable form is used. The advantage of using a computer readable format includes the easy computerized tabulation of the physical copy of the votes, should such become necessary, and further prevents poll workers or others who might gain access to the voting records from ascertaining through visual inspection any voter's selections. A voter's selections may be recorded, both on the redundant hard drives and by printing, after a voter completes a ballot.

The computer provided in the first compartment 610 may also assist in the tallying and reporting of the election results. The computer may be used to provide ongoing tally of votes as the election progresses. The computer may also use appropriate networking methods and equipment to communicate with other equipment at the polling location or at a remote election office. For example, the computer may be equipped with an appropriate network card to allow it to communicate with other computers located at the polling place, potentially in other voting apparatuses. Such networking may employ suitable physical connections or may be conducted wirelessly. Furthermore, a modem or other connection may be provided to allow the computer to transmit election results to a centralized computer used by election officials to tabulate and/or report election results. One skilled in the art will realize that such communication methods are standard procedures for numerous applications in common usage today.

The second compartment 620, which is accessed using the second door 720, contains peripherals which are used to facilitate voting by any individual, regardless of his or her particular disability. Peripherals typically stored within the second compartment 620 would include a joystick and alternative joystick knobs such as a chin cup, sponge ball, finger tube, and wrist plate, to allow a wide range of individuals to use a joystick device to indicate ballot selections. Any other peripheral device that could be advantageous for voting purposes could be stored within the second compartment. Examples of additional peripherals that may be used include sip and puff devices, head movement eye blink devices, and a foot operated switch. Additionally, an electronic stylus and pad assembly that is capable of recording hand writing is preferably included with the other peripherals. The electronic stylus and pad may be used by a voter to cast a write-in selection, if such is permitted in the relevant jurisdiction. A voter's write in selection cast using the stylus and pad could be stored as a graphical file on the redundant hard drives and printed by the printer. Alternatively, handwriting recognition software could be used to convert a written selection to an appropriate text file for recording on the hard drives, with the printer recording simple text of the write in selection. Sanitary supplies may also be stored in the compartment 620. For example, cleaning and sterilizing supplies may be stored to allow the various components of the voting apparatus 100 to be cleaned at regular intervals to protect the health of the individuals using it. Additionally, extra supplies such as additional straws and bladders for use with a sip and puff device may be stored in the second compartment 620.

Referring further to FIG. 7, it should be noted that appropriate latches and locks 730 may be provided upon the first door 710 and second door 720, so as to prevent unauthorized individuals from accessing either the computer or the assorted peripherals. Also provided on the back face 113 of the box 110 is a switch 770 to activate or deactivate the electric motor and winch 410.

Referring again to FIG. 6, it should be noted that a voting status light 260 and an operational indicator light 270 are provided upon the telescoping curtain rod 236. The voting status light 260 is activated whenever the voter completes the voting process, to indicate to a poll worker or attendant that the voter has completed the voting process so that any necessary assistance can be provided to the voter. The voting status light 260 will also operate in a second mode, wherein it will flash to indicate that the voter has signaled a question or that some assistance is required from a poll worker or attendant. The operational indicator light 270 may be used to indicate that the voting apparatus 100 requires servicing or attention. For example, the operational indicator light 270 could be activated if the printer runs out of paper, or if the computer experiences a malfunction.

Referring further to FIG. 6, the fully assembled voting apparatus 100 is shown. However, the curtain 320 is omitted from FIG. 6 to allow illustration of the interior of the box 110. It is to be observed that the space 630 between the first compartment 610 and the second compartment 620 serves a variety of functions. First, the space 630 provides a place for a voter in a wheelchair to place his or her feet and legs, should additional room be required. Additionally, the space 630 provides a location for numerous pieces of equipment important to the operation of the voting apparatus 100. First, within the space 630 is the control module 640 for the apparatus 100. Essentially, the control module 640 allows the various peripheral devices used with the voting apparatus 100 to communicate with the computer and touch screen.

Additionally, the screen assembly 800 is positioned within the space 630. The screen assembly 800 is mounted upon an adjustable position support arm device 805 slidably mounted on the support beam 234. This allows for the screen assembly 800 to be positioned in a way that best suits each individual voter. Also included within the space 630 with the screen assembly 800 is a computer keyboard tray containing both a computer keyboard and a braille board, as described more fully below.

When the voting apparatus 100 is in operation, the provided peripherals such as a sip and puff, joystick, or other voter ballot selection device, can be moveably supported by the use of adjustable position support arms 690, 695. Adjustable position support arms are slidably attached to each of the side support beams 224. The use of multiple position support arms 690, 695 provides enhanced flexibility of configuration of the voting apparatus 100 to accommodate a wide range and variety of voters with divergent needs and preferences. Additionally, the use of two adjustable position support arms 690, 695 allows a larger number of provided peripheral devices to be deployed within the voting apparatus 100 at any given time. For example, the provision of two adjustable position support arms 690, 695 allows for both a sip and puff device 680 and a joystick 685 to be deployed simultaneously, thereby reducing the need for poll workers to adjust or modify the devices deployed for every given voter depending upon that voter's needs. Additionally, it is possible, and may in some cases be advisable, to deploy more than one peripheral device upon a single adjustable position support arm 690, 695. It should further be noted that the adjustable position support arms 690, 695 may include an ergonomic arm rest 696. The provision of an ergonomic arm rest 696 is particularly desirable for use with a joystick 685 or other device that is manipulated using a hand or fingers. Such an arm rest allows an individual who may not have full control of his or her extremities to rest their arm upon the arm rest 696 while manipulating the joystick 685 or other device to input ballot selections.

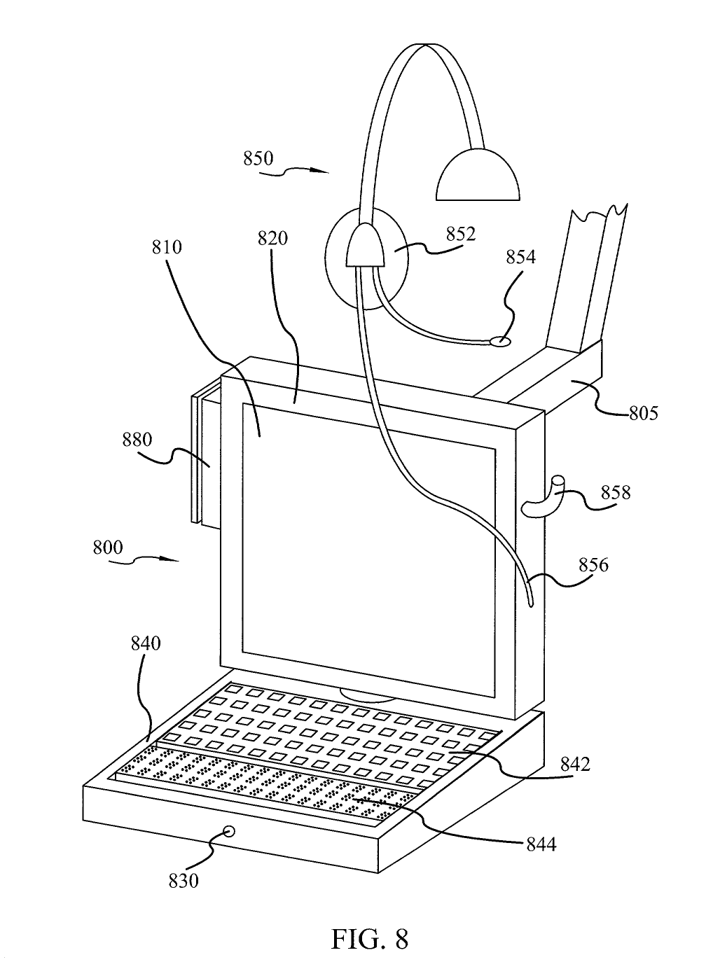

Referring now to FIG. 8, a screen assembly 800 for use in conjunction with the present invention is shown. The screen assembly 800 includes a screen 810 for the display of ballot information. The screen 810 may comprise a touch sensitive screen that may receive a voter's ballot selections when the voter touches a portion of the screen 810. Numerous suitable touch screens are commercially available from assorted manufacturers. The screen assembly 800 is supported by an adjustable position support arm device 805. The adjustable position support arm device 805 is slidably mounted upon the support beam 234 of the canopy portion 230 of the frame 200.

The screen assembly 800 also includes a case 820 that serves to protect the electronics associated with the screen 810 and to provide a means for mounting additional equipment. An infrared transmitter/receiver 830 is provided on the case 820. The infrared transmitter/receiver 830 provides one means of establishing an infrared link between the voting apparatus 100 and infrared enabled auxiliary peripheral control modules. While the infrared transmitter/receiver 830 could be positioned elsewhere on the voting apparatus 100, its location on the screen assembly 800 allows for its location to be adjusted using the adjustable position support arm 805 that supports the screen assembly.

Also provided with the screen assembly 800 is a tray 840. The tray 840 retains a keyboard 842 and a refreshable braille board 844. The keyboard 842 may comprise a sealed computer keyboard with braille characters provided on the keys thereof, although standard or other specialized keyboards may be used as well. The keyboard 842 may be employed by a voter as one method of inputting ballot selections. The refreshable braille board 844 is also retained within the tray 840 and serves to output ballot information in braille form to voters who prefer or require such a tactile format. The tray 840 may be formed integrally with the case 820, or may be a separate attachment to the case 820. While the tray 840 may be rigidly affixed to the case 820, in the present embodiment the tray 840 may be rotated relative to the case 820 to allow a voter to rotate the tray 840 to gain easier access to the screen 810. One skilled in the art will realize that a variety of devices and/or constructions may be used for this purpose. Both the case 820 and the tray 840 may be constructed of a number of suitable materials, such as plastic, metal, wood, or laminated wood.

Also included with the screen assembly 800 is an audio assembly 850. The audio assembly 850 comprises headphones 852, a microphone 854, and appropriate cable 856. Further provided is a hook 858 to retain the audio assembly 850 when it is not in use. The headphones 852 may be used by a voter to receive ballot information in an audio format. Audio ballot information may be retained in a number of ways. Audio ballot information may be provided using a generally available text reader to use the computer to convert ballot information stored in a text form to audio output. Audio ballot information may also be retained on a computer hard drive in a digital format, such as MP3, for play when needed by a voter. One skilled in the art will further realize that any digital or non-digital format may be employed with the present invention. The microphone 854 receives spoken ballot selections from the voter and, operating in conjunction with appropriate speech recognition software on the computer, allows the voter's selections to be input and recorded. The cable 856 provides an appropriate operable connection between the headphones 852 and microphone 854 and the remainder of the voting apparatus 100.

While the audio assembly 850 may be used to provide for spoken input of ballot selections using any desired method of speech recognition, the method ultimately used should ideally be simple enough to use so that voters who may be unfamiliar with that particular method, or speech recognition in general, may use the speech recognition capabilities of the apparatus 100 to make ballot selections. Moreover, the voter's privacy should be respected in the implementation of the speech recognition system. For example, requiring a voter to speak the name of a candidate should be avoided, as that could compromise the secrecy of that voter's ballot. The speech commands required from a voter should be limited in number and selected to avoid disclosing a voter's selections to those within earshot of the apparatus 100. For example, commands such as “yes”, “no”, “next”, “up”, “down”, and “help” may be used.

The audio assembly 850 may also be used in an “interview” used to prepare an individual's electronic voice print for use with the spoken input of information. Such an interview may occur immediately prior to voting, but may also occur well before election day, such as at the time of voter registration.

Also included with the screen assembly 800 is a card reader 880. The card reader 880 is capable of mechanically or electronically reading stored information from a voter registration card. The card reader 880 may, for example, comprise a magnetic strip reader, a bar code reader, any other reader that could appropriately retrieve information stored on a card or similar item, or any combination of these readers. Additionally, in some applications the card reader 880 may also possess the ability to write information to a voter registration card, so that a voter may change information stored on his or her voter registration card, such as an address, during the process of using the voting apparatus 100. Using the card reader 880 to write information to a voter registration card also allows the apparatus 100 to be used to prepare cards during voter registration or to prepare replacement cards. The use of the card reader 880 and readable voter information cards can facilitate the voting process by allowing a voter to authenticate his or her registration to vote by simply providing his or her voter registration card to the card reader 880. It should be noted that voter identification information may potentially be stored in a magnetic or other form on an individual's drivers license, particularly in light of the so called “Motor Voter” law. If desired, additional information beyond mere voter registration details may be retained on a card for use with the card reader 880. Relevant and useful information of this type could include information regarding peripheral devices desired, needed, or preferred by that individual voter, or may include information to assist or enable the computer to retrieve a voice print or other information regarding that voter to facilitate the voting process through means such as speech recognition software.

While the card reader 880 is not strictly required to possess writing capabilities to practice the present invention, using the card 880 to write information to a voter's registration card allows the voting apparatus to be used for registration purposes as well. It should be noted that the multiple methods of inputting and outputting information provided by the apparatus 100 makes it well suited to serving additional functions, such as the registration of individuals to vote. Another example of a service for which the apparatus 100 is well suited is the preparation of “voice prints” for use by voters who wish to use speech input of their ballot selections. Such a voice print may be stored on one or more of the computer hard drives, or elsewhere, and information allowing that voice print to be retrieved can be written to a voters registration card.

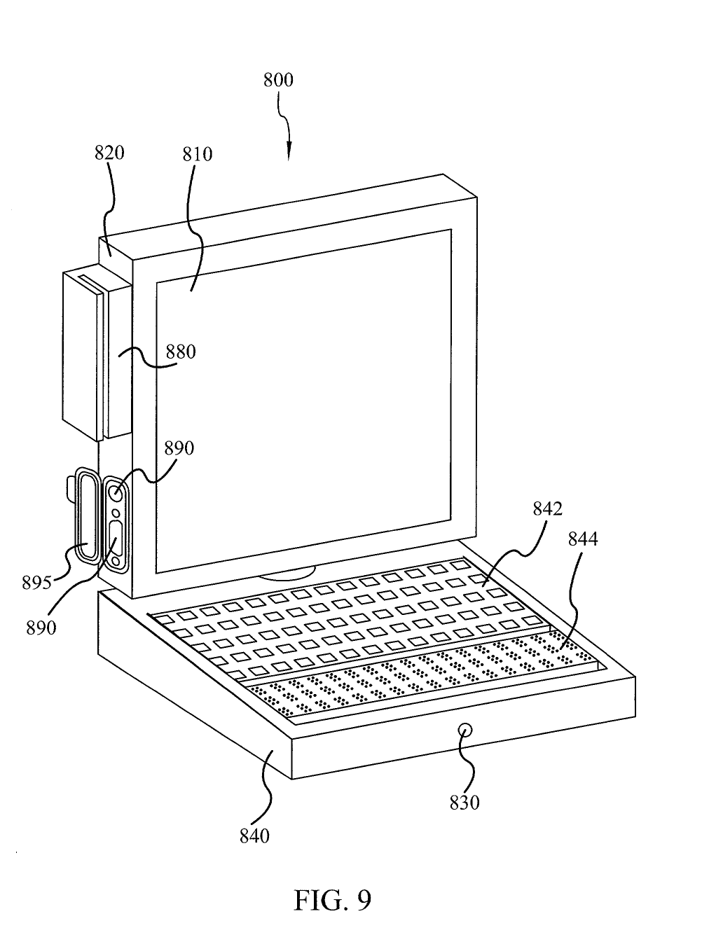

Referring now to FIG. 9, further aspects of the screen assembly 800 are illustrated. Jacks 890 are provided as part of the screen assembly 800 to receive cable connections from any auxiliary peripheral devices and control modules provided or used by the voter. These jacks 890 serve essentially the same purpose as the infrared transmitter/receiver 830 in that they allow auxiliary peripheral equipment to operably connect to the voting apparatus 100 using cables so that a voter may use his or her typical and preferred peripheral equipment in the voting process. A removable cover 895 is provided to enclose and protect the jacks 890 when they are not in use.

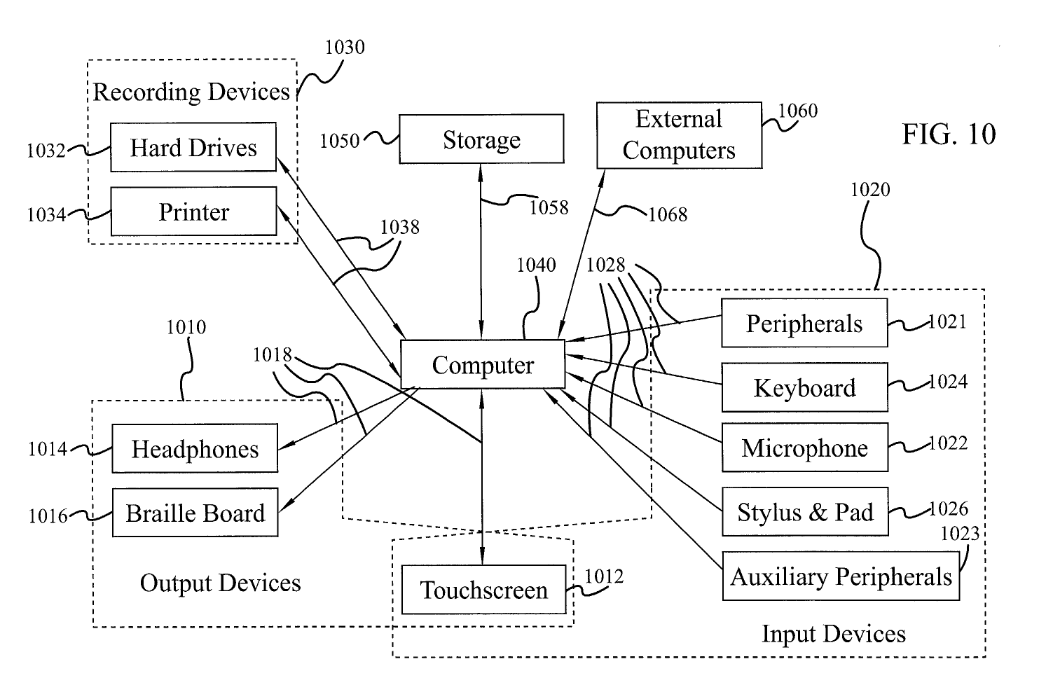

Referring now to FIG. 10, some of the functional aspects and elements of the voting apparatus 100 are illustrated schematically. Essentially, the voting apparatus 100 comprises output devices 1010, input devices 1020 and recording devices 1030 that operate through the computer 1040 and other appropriate modules and communication links.

The output devices 1010 may include a touch screen 1012, headphones 1014, and a braille board 1016. In general, the output devices 1010 are used to provide ballot information to a voter. As described in more detail above, the output devices 1010 comprise a first output device, such as the touch screen 1012, that outputs ballot information that a voter perceives using a first sense, such as sight, a second output device, such as the headphones 1014, that outputs ballot information that a voter perceives using a different second sense, such as hearing, and optionally a third output device, such as a refreshable braille board 1016, that outputs ballot information that a voter perceives using a different third sense, such as touch. The ballot information provided using the output devices 1010 is provided by the computer 1040 from computerized storage 1050. It should be appreciate that ballot information may be stored in a variety of ways. For example, ballot information may be retained in computer storage 1050 in a single file type that is then converted to a form appropriate for output using a particular output device 1010. Alternatively, ballot information may be retained in storage in separate types of files for each of the provided output devices 1010. One skilled in the art will realize that appropriate hardware and software 1018 must be employed to form an operable connection between the computer 1040 and the output devices 1010 and to allow the computer 1040 to operate in conjunction with the various output devices 1010. One skilled in the art will further realize that the appropriate hardware and software 1018 used to form an operable connection will likely differ depending on the particular output device 1010 being used. For example, a refreshable braille board 1016 will typically require different hardware connections and software drivers to interface with the computer 1040 than will the touch screen 1012.

It is to be appreciated that numerous output devices 1010 other than those specifically enumerated herein can be employed in conjunction with the voting apparatus 100. To employ additional or different output devices 1010, the user would simply need to provide the appropriate hardware and software 1018 to operably connect that output device 1010 to the computer 1040. This flexibility of specific output devices 1010 used allows the voting apparatus 100 in accord with the present invention to be modified, maintained, and upgraded as the art advances.

The voting apparatus 100 also includes input devices 1020. In general, input devices 1020 operate to receive a voter's ballot selections, or other input if the apparatus is being used for other purposes such as voter registration. It should be observed that the touchscreen 1012 serves as both an input device 1020 and an output device 1010. Another example of an input device 1020 is the microphone 1022 which receives oral selections from a voter. Another input device is a keyboard 1024 to receive ballot selections from a voter. Yet another appropriate input device 1020 would be a stylus and electronic pad 1026, to receive written voter input, particularly in the nature of write in candidates. One important category of input device 1020 is the peripherals 1021 provided with the voting apparatus 100. Provided peripherals 1021 may include peripheral assistance items such as a joystick, a sip and puff device, a foot switch, a head position eye blink device, or any similar or related items provided with the voting apparatus 100 to allow voters with limited motor abilities to effectively input ballot selections. Input devices 1020 may also include auxiliary peripherals 1023. Auxiliary peripherals 1023 would include devices provided by a voter that are used to interface with the voting apparatus 100, for example for use by the infrared transmitter/receiver 830 or by use of the jacks 890. As described in more detail above, the input devices 1020 may be viewed as a first input device, such as a touchscreen 1012, that allows a voter to input ballot selections using a first physical action, such as touching a portion of the touchscreen 1012, and a second input device, such as a microphone 1022, that allows a voter to input ballot selections using a second physical action, such as speaking. Other input devices 1020, such as peripherals 1021, the keyboard 1024, the stylus and pad 1026, auxiliary peripherals 1023, or any other appropriate device, may be used as a first input device, a second input device, or as additional third, fourth, or other input devices.

It should be appreciated that the voting apparatus 100 in accordance with the present invention provides for great flexibility in the provided peripherals 1021 that are employed at any time. The provided peripherals 1021are operably connected with the computer 1040 using appropriate hardware and software 1028 that includes a control module 640 suitable for the particular standard employed for communications purposes by those peripherals 1021. Ideally, all provided peripherals 1021 will employ the same standards, and therefore use the same control module 640. While multiple control modules 640 could be used, the design of the voting apparatus 100 is simplified if a unitary standard is used by the provided peripherals 1021. It is to be appreciated, however, that varying combinations of the peripherals disclosed herein, as well as additional peripherals 1021 that were not disclosed herein or that may be developed hereinafter, may be employed as provided peripherals 1021. This enables a voting apparatus 100 in accordance with the present invention to be flexibly configured to serve a wide range of individuals and to be modified over time. For example, a particular polling place may not require a sip and puff device to serve the voters registered to use that polling location. Accordingly, the election officials may purchase a voting apparatus 100 that does not include a sip and puff device. Subsequently, a need may arise for a sip and puff device at that polling location. A voting apparatus 100 in accordance with the present invention easily provides for the inclusion of such a device at a later time, particularly if that device is selected to interface using the same standards and control modules 640 already provided with the voting apparatus 100.

In consideration of auxiliary peripherals 1023, it should be noted that a variety of manufacturers of such peripherals 1023 use differing standards for the communication links used by their devices. Typically, an auxiliary peripheral 1023 will have provided with it a control module that will receive and relay signals to and from that particular peripheral device 1023. That control module will then interface with other devices that employ the same communication link standards supported by that control module. One skilled in the art will realize that the situation, with differing manufacturers employing differing communication link standards, poses an obstacle to the effective use of universal communication links for these peripheral devices. Accordingly, it is one aspect of the present invention to provide appropriate software for use by the computer 1040 to recognize the varying standards employed by differing manufacturers of peripheral devices 1023. Once the computer 1040 identifies the standard being employed by the auxiliary peripheral 1023, the computer 1040 would then adopt for purposes of that voting session the standards used by that peripheral 1023. This enables a voting apparatus 100 in conjunction with the present invention to accommodate the broadest possible range of voters.

One skilled in the art will realize that the input devices 1020 will be operably connected with the computer 1040 using appropriate hardware and software 1028. As with the output devices 1010, the appropriate hardware and software 1028 used with the input devices 1020 may vary. For example, the appropriate hardware and software 1028 used with the provided peripherals 1021 to allow those peripherals 1021 to effectively communicate with the computer 1040 may typically include appropriate cabling or wires and a control module 640 to interface between the peripherals 1021 and the computer 1040. It should be noted that any auxiliary peripherals 1023 employed as an input device 1020 will typically possess their own control module which will establish the communication link with the computer 1040 using the appropriate communication standards as described above. Other input devices 1020 such as the keyboard 1024, the microphone 1022, and the stylus and pad 1026 will, of course, also require appropriate hardware and software 1028 to effectively interface with the computer 1140.

After a vote has been cast, it must be recorded for subsequent counting to determine the outcome of an election. For this purpose, recording devices 1030 are employed. As set forth in some detail above, appropriate recording devices include redundant computer hard drives 1032 and a printer 1034. Additionally, ballot information must be retained so that the information may be provided to a voter in an appropriate form. Ballot information may be retained in computer storage 1050, where the information can be accessed by the computer 1040 and provided to a voter. Computer storage 1050 may comprise a cd, a so called zip drive, a computer hard drive, or any other appropriate storage device. In some applications, the hard drives 1032 may be used for computer storage 1050.

The computer 1040 may also be used to communicate with external computers 1060, either at the polling place or at other locations. For example, standard or specially adapted networking methods 1068 may be used to allow the computer 1040 to operably connect with other computers 1060, potentially integral to other voting equipment, at the polling place to back up data, update vote tallies, or monitor usage and voter flow. The computer 1040 may also include a modem or other device to allow it to transmit vote tallies to a computer 1060 at a centralized remote location where overall election results are computed and/or reported. Those skilled in the art will realize that numerous ways of establishing such electronic communications links exist, that certain security risks may be posed in the use of such links and how to address those risks.

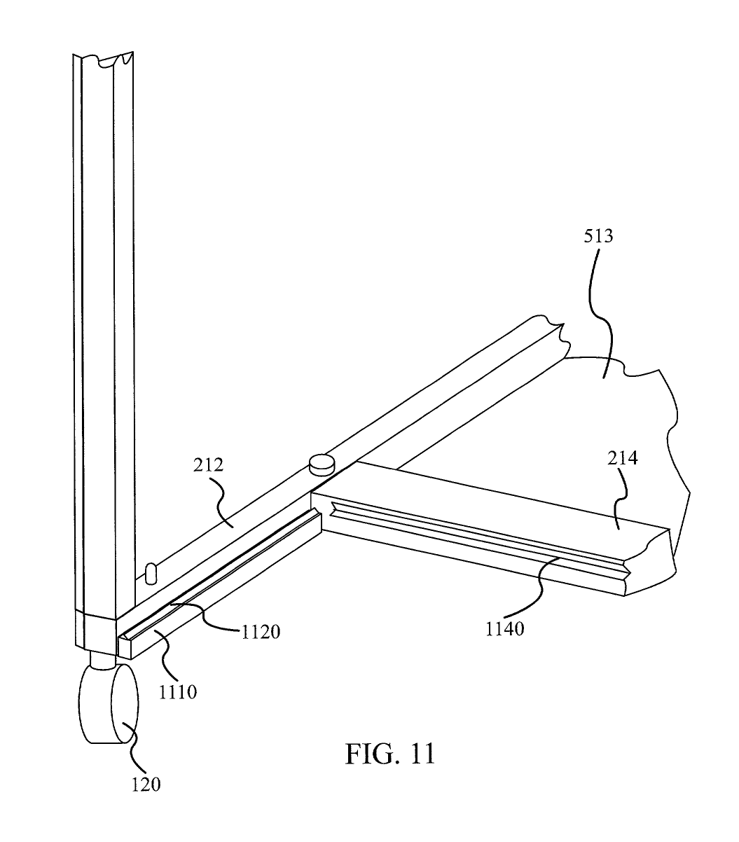

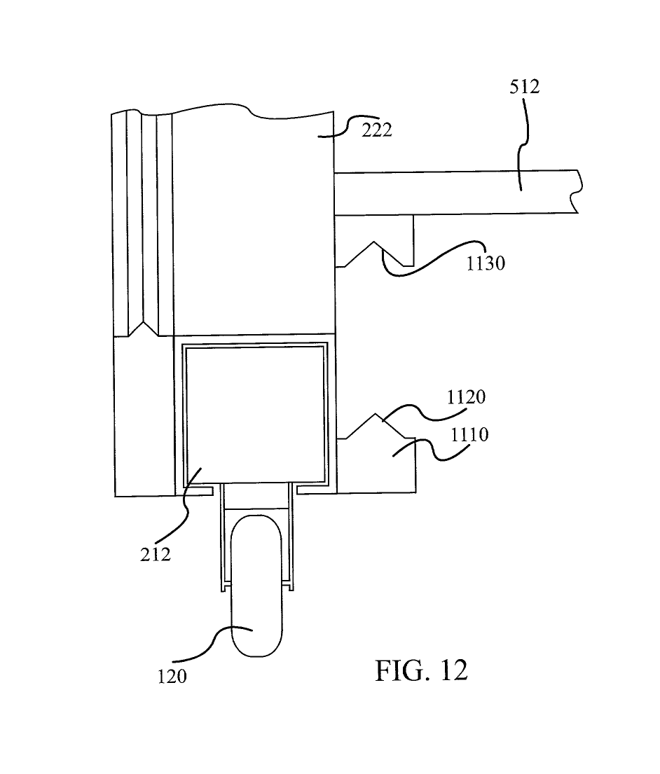

Referring now to FIGS. 11 and 12, the means of sealing bottom face 114 is shown in greater detail. Particularly, the method for closing and sealing the portion 512 of the bottom face 114 that is attached by hinges 134 to the front face 111 is shown. The portion 512 of the bottom face 114 is removed from the remainder 513 of the bottom face 114 when the voting apparatus 100 is in use to provide floor access by individuals using wheelchairs. Additionally, the weight of the portion 512 of the bottom face 114 on the erected canopy 605 provides a useful counterbalance to the extended curtain rod 236 and curtain 320. However, it is advantageous to return the portion 512 of the bottom face 114 to effectively seal the box 110 from water or other damaging elements during storage and, particularly, transportation of the voting apparatus 100. To this end, a rail 1110 is attached to each of the horizontal bars 212 of the base 210. The rails 1110 are positioned such that the portion 512 of the bottom face 114 rests thereon when the box 110 is closed for storage or transportation. The rails may contain a ridge 1120 thereon which mates with a corresponding valley 1130 on the portion 512 of the bottom face 114. The use of the ridge 1120 and valley 1130 further facilitates the proper placement of the portion 512 of the lower face 114 when the canopy 605 is lowered using the electric motor and winch 410. When the canopy 605 is lowered, the portion 512 of the bottom face 114 is lowered onto the rail 1110 and engages the ridge 1120 thereon with the valley 1130 of the portion 512 of the lower face 114. The portion 512 of the lower face 114 then swings on the hinges 136 as the canopy is lowered and slides into place. It should be further noted that a groove 1140 may be provided on the orthogonal bar 214 of the base 210 to receive the leading edge of the portion 512. The groove 1140 retains the portion 512 in place, even if the apparatus is transported over an irregular surface. This use of a combination of ridges and valleys provides for a secure and substantially water tight seal to allow the voting apparatus 100 to be stored and transported without endangering the contents thereof unduly. One skilled in the art will realize that various means may be used to achieve the same end, and that in some circumstances where protection from the elements is not required, these means can be dispensed with altogether.

While an embodiment of the present invention has been described in considerable detail above, those skilled in the art will appreciate that the present invention is not limited to the embodiment and variations thereof described above. For example, the locations of assorted portions of the apparatus 100 may be varied. The compartments 610, 620 may be located differently or dispensed with as discreet physical spaces in some circumstances. The computer 1140 may be provided externally to the remainder of the apparatus 100, for example at a more remote location, and accessed using appropriate confections such as ethernet, other physical connections, or wirelessly.

The connections between the peripherals, the screen assembly, the control module and the computer that transmit signals between these devices may take a variety of forms. One skilled in the art will likely be most familiar with physical connections, typically using appropriate cables, but will realize that other types of connections are possible. For example, wireless connections utilizing infrared, radio frequencies, or other media may be employed.

The peripherals 1021 provided with the apparatus 100 may be expected to vary greatly. For example, some polling places may not immediately require all the peripherals 1021 enumerated herein, such as a sip and puff device. Additional peripherals 1021 may be developed in the future, or may presently exist without specific mention herein. One benefit of the present invention is that such peripherals may be easily added to the apparatus 100 at the time that they become necessary, desired, or available. While the peripherals 1021 provided with the apparatus ideally utilize a single communication standard and a single control module 640, this is not required.

Additionally, certain aspects of the invention, while useful, may be dispensed with. In a broad sense, the present invention involves the provision of multiple means of receiving and inputting data. This broad sense can be attained without all of the elements described in the embodiment disclosed herein, or with varying elements other than those described herein. Particular embodiments of this broad invention may lack particular elements, such as specific peripherals 1021 described herein, particular interface aspects, computing parameters, and the like.

While the embodiment described herein is particularly suited for use with a computerized voting system, the broader aspects of the present invention may be utilized without the use of a broader computerized system. For example, data tabulated by the computer 1140 included in the apparatus 100 may be simply added to vote totals obtained through the counting of ballots cast in another manner, such as through the use of a punch card system or an optical scanning system. Potentially, the apparatus 100 disclosed herein could be used to print or otherwise prepare a ballot for counting using other standard methods, such as punch card or optical scanning balloting. The use of the apparatus 100 disclosed herein is particularly well suited to use with a generally computerized voting system, however, because in such a system no indication is given that a particular vote was cast by an individual with a disability. Other systems that involve the use of the apparatus 100 to print or otherwise prepare a ballot are less desirable, because and examination of such ballots could indicate that they were cast by disabled individuals. Nevertheless, such system would not depart from the broad spirit and scope of the present invention.

One skilled in the art will realize that numerous other variations may be made, without departing from the scope of the invention as set forth in the following claims.

1. An information kiosk comprising:
a first output device to provide information to the user of the kiosk, wherein the user perceives information from the first output device using a first sense;
a second output device to provide information to the user of the kiosk, wherein the user perceives information from the second output device using a second sense different from the first sense;
a first input device, wherein the user inputs information via the first input device using a first physical action;
a second input device, wherein the user inputs information via the second input device using a second physical action different than the first physical action;
a storage device to retain information for output to the user; and
a recording device to record information input by the user.

2. The kiosk of claim 1, wherein the information retained for output to the user is ballot information and wherein the information recorded from the user is ballot selections.

3. The kiosk of claim 1 wherein the storage device and recording device comprise a computer hard drive.

4. A voting apparatus comprising:
a computer to process ballot information and selections;
a storage device to retain ballot information, the storage device being operably connected to the computer such that the computer may access the ballot information;
a recording device to record ballot selections, the recording device being operably connected to the computer such that the computer may control the recording of ballot selections;
output devices to provide ballot information to a voter, the output devices operably connected to the computer such that the computer transmits ballot information to the output devices to be provided to the voter, the output devices comprising;
a first output device, wherein the voter perceives information from the first output device using a first sense; and
a second output device, wherein the voter perceives information from the second output device using a second sense different than the first sense;
input devices to receive ballot selections from the voter, the input devices being operably connected to the computer such that the input devices transmit ballot selection received from the voter to the computer, the input devices comprising;
a first input device wherein the voter inputs ballot selections via the first input device using a first physical action; and
a second input device, wherein the voter inputs ballot selections via the second input device using a second physical action different that the first physical action.

5. The voting apparatus of claim 4, wherein the first output device and the first input device comprise a touch sensitive screen.

6. The voting apparatus of claim 5, wherein the output devices further comprise a third output device wherein the voter perceives information from the third output device using a third sense, the third sense being different that the first sense and the second sense.

7. The voting apparatus of claim 5, wherein the input devices further comprise a third input device, wherein the voter inputs a ballot selection via the third input device using a third physical action, the third physical action being different than the first physical action and the second physical action.

8. The voting apparatus of claim 6, wherein the input devices further comprise a third input device, wherein the voter inputs a ballot selection via the third input device using a third physical action, the third physical action being different that the first physical action and the second physical action.

9. The voting apparatus of claim 5, wherein the recording device comprises a computer hard drive.

10. The voting apparatus of claim 5, wherein the recording device comprises a printer.

11. A voting apparatus comprising:
a frame further comprising:
a base, the base having at least two legs capable of temporarily extending outwardly in opposing directions, with a wheel attached to each of the telescoping legs; vertical rods extending upward from the base capable of temporarily extending upward;
a canopy portion affixed to the vertical rods opposite of the base, the canopy portion affixed to the vertical rods such that the canopy portion is raised when the vertical rod rods are temporarily extended upward;
a box mounted on the frame, the box comprising:
a top face affixed to the canopy portion of the frame, the top face being capable of raising with the canopy portion of the fame;
a back face affixed to the frame such that the back face remains stationary when the canopy portion is raised, the back face abutting the top face without being permanently secured thereto;
a left face affixed to the frame such that the left face remains stationary when the canopy portion is raise, the left face abutting the top face without being permanently secured thereto and the left face abutting the back face;
a right face affixed to the frame such that the right face remains stationary when the canopy portion is raised, the right face abutting the top face without being permanently secured thereto and the right face abutting the back face opposite from the left face;
a front face hingedly affixed to the top face, the front face abutting the left face and the right face without being permanently affixed thereto, the front face capable of being folded over the top face and raised with the canopy portion of the frame and;
an interior defined by the top face, the back face, the left face, the right face, and the front face;
a computer to process ballot information and selections;
a storage device to retain ballot information, the storage device being operably connected to the computer such that the computer may access the ballot information;
a recording device to record ballot selections, the recording device being operably connected to the computer such that the computer may control the recording of ballot selections;
ballot output devices to provide ballot information to a voter, the output devices movably affixed within the interior of the box and operably connected to the computer such that the computer transmits ballot information to the output devices to be provided to the voter, the output devices comprising;
a first output device, wherein the voter perceives information form the first output device using a first sense; and
a second output device, wherein the voter perceives information from the second output device using a second sense different than the first sense;
input devices to receive ballot selection from the voter, the input devices movably affixed within the interior of the box and operably connected to the computer such that the input devices transmit ballot selections received from the voter to the computer, the input devices comprising:
a first input device, wherein the voter inputs ballot selections via the first input device using a first physical action; and
a second input device, wherein the voter inputs ballot selections via the second input device using a second physical action different that the first physical action; and
wherein the canopy portion, top face, and front face are temporarily raised to allow a voter to access the input devices and the output devices within the interior of the box.

12. The voting apparatus of claim 11 wherein the first output device and the first input device comprise a touch sensitive screen.

13. The voting apparatus of claim 12 wherein the recording device comprises a computer hard drive.

14. The voting apparatus of claim 13 further comprising:
a first compartment within the interior of the box, wherein the computer, the recording device, and the storage device are located within the first compartment;
a first door allowing access to the first compartment through the back face;
a second compartment within the interior of the box, wherein the second output device and the second input device are stored therein when the voting apparatus is not in use; and
a second door allowing access to the second compartment through the back face.

15. The voting apparatus of claim 14 further comprising a space in the interior of the box between the first compartment and the second compartment, wherein the input devices and the output devices may be positioned therein while the voting apparatus is in use.

16. The voting apparatus of claim 15 further comprising:
an auxiliary input device to receive ballot selection from peripheral devices provided by a voter.

17. The voting apparatus of claim 16, wherein the input devices and th output devices are movably positioned using at least one adjustable position support arm.

18. The voting apparatus of claim 17, further comprising a telescoping curtain rod affixed to the canopy portion such that the curtain rod may be extended outwardly from the canopy portion and a curtain affixed thereto to substantially obscure a voter using the apparatus from others.

19. The voting apparatus of claim 18 wherein the input devices further comprise a third input device, wherein the voter inputs a ballot selection via the third input device using a third physical action, the third physical action being different than the first physical action and the second physical action.

20. The voting apparatus of claim 19, wherein the output devices further comprise a third output device, wherein the voter perceives information from the third output device using a third sense, the third sense being different that the first sense and the second sense.
